(19) United States
(12) Patent Application Publication
(10) Pub. No.: US 2013/0314042 A1
(43) Pub. Date: Nov. 28, 2013

(54) Method for Ascertaining the Open Circuit Voltage of a Battery, Battery with a Module for Ascertaining the Open Circuit Voltage and a Motor Vehicle Having a Corresponding Battery

(71) Applicants: Andre Boehm, Kornwestheim (DE); Stefan Wickert, Albershausen (DE)

(72) Inventors: Andre Boehm, Kornwestheim (DE); Stefan Wickert, Albershausen (DE)

(73) Assignees: Samsung SDI Co., Ltd., Yongin-si, Gyeonggi-do (KR); Robert Bosch GmbH, Stuttgart (DE)

(21) Appl. No.: 13/990,507

(22) PCT Filed: Nov. 21, 2011
(86) PCT No.: PCT/EP2011/070522

§ 371 Date: Aug. 9, 2013

(30) Foreign Application Priority Data
Nov. 30, 2010 (DE) 102010062187.0

(51) Int. Cl. B60L 11/18

(52) U.S. Cl. CPC B60L 11/1809
USPC 320/109; 320/162

(57) ABSTRACT

The present disclosure relates to a method for ascertaining the open circuit voltage (OCV) of a battery, to a battery with a module configured to ascertain the open circuit voltage and to a motor vehicle having a corresponding battery, which is configured to ascertain the ageing-dependent open circuit voltage of battery packs installed in a vehicle. To this end it is proposed to determine the open circuit voltage during the charging operation of the battery. Furthermore proposed are a battery having a module for ascertaining the open circuit voltage of a battery, and a vehicle having a battery of this type.

The present invention relates to a method for ascertaining the open circuit voltage (OCV) of a battery, to a battery with a module for ascertaining the open circuit voltage, and to a motor vehicle having a corresponding battery, which can be used, in particular, to ascertain the ageing-dependent open circuit voltage of battery packs installed in a vehicle.

Prior Art

In hybrid and electric vehicles, batteries and battery packs are used in lithium-ion or nickel-metal hydride technology and are composed of a large number of electrochemical cells which are connected in series.

In order to monitor the battery, a battery management system (BMS) is provided which is intended to ensure safety monitoring and the longest possible service life.

For this purpose, the voltage of each individual cell is measured together with the battery current and the battery temperature by the battery management system and a state estimation with respect to the State of Charge (SOC) and the State of Health (SOH) is made.

According to the prior art, as in, for example, DE 10 2008 041 300 A1, this is ascertained using a control-technology observer structure which observes the real system battery by means of a model and ascertains the state of the real system by adaptation of the model parameters. The core of this observer structure or of this observer structure is a model of an electrochemical cell. In this context, the battery voltage is calculated from the summands of the open circuit voltage and the voltage drop at the complex impedance of the cell. In addition to a high-quality model for the cell impedance, precise knowledge of the open circuit voltage is necessary here. This can be ascertained punctually in advance for the installed cell type in the laboratory, wherein, on the basis of these values, a table is formed which describes the dependence of the open circuit voltage on the state of charge, with the result that the state of charge can be determined. This so-called OCV table is therefore ascertained in the laboratory.

However, owing to ageing, it is possible that the open circuit voltage changes structurally if, for example, the anode and cathode of the cell age to different degrees. It is therefore not possible to use the battery management system of a vehicle to reliably detect the changing open circuit voltage in the real system.

### DISCLOSURE OF THE INVENTION

According to the invention, a method for ascertaining the open circuit voltage of a battery is made available, in which, within the scope of the method, the ageing-dependent open circuit voltage of the battery installed in the vehicle or a characteristic curve of the open circuit voltage (OCV characteristic curve) is easily determined. This is achieved by virtue of the fact that the open circuit voltage is determined during the charging process of the battery. In contrast to the prior art, where the open circuit voltage is considered to be constant over the service life of the battery, the invention provides for the changing open circuit voltage to be determined during the operation of the battery in the vehicle.

It has proven advantageous if the characteristic curve of the open circuit voltage which is stored in a battery management system is adapted as a function of the open circuit voltage determined during the charging process. A preferred embodiment provides that the OCV table which is stored in the battery management system is also newly determined as a function of the open circuit voltage determined during the charging process. As a result it is advantageously possible to correct model errors which are possibly present.

The battery is at least one electrochemical cell, but preferably a battery having a multiplicity of electrochemical cells, wherein the electrochemical cells are connected in series. The battery is preferably a lithium-ion battery.

In one preferred embodiment of the invention there is provision that the cell voltage and the voltage drop at the impedance of at least some of the electrochemical cells, but preferably of all the electrochemical cells, are ascertained. The open circuit voltage is determined by subtracting the voltage drop from the cell voltage.

It proves particularly advantageous if a cell model which is used in a battery management system is utilized during the determination of the open circuit voltage. By means of the battery management system, inter alia the temperature, cell current, state of charge or the like are detected or ascertained. The voltage drop at the impedance of at least some of the electrochemical cells, but preferably of all the electrochemical cells, is calculated by the cell model using the values detected or ascertained in this way.

The open circuit voltage is then determined by substracting the voltage drop from the measured cell voltage.

In a further preferred embodiment of the invention, there is provision that continuous charging takes place, that is to say the charging power and/or the charging current are kept constant during the charging process.

An alternative preferred embodiment provides that the charging is carried out with a changing charging current. It proves advantageous if the charging current changes continuously. This has the advantage, in particular, that in this context the impedance can be determined particularly precisely. It also proves advantageous if low charging currents are used since the voltage drop at the impedance is then low.

Alternatively it is possible to provide for the open circuit voltage to be determined during non-continuous charging.

Another preferred embodiment provides that the changes in the OCV characteristic curve are subjected to filtering. By means of this filter algorithm, for example faults during the measurement of the voltage are eliminated, with the result that, for example, brief faults do not have an adverse effect on the determination of the open circuit voltage.

It proves particularly advantageous if, in order to determine the open circuit voltage, the entire range of the state of charge of the battery is run through, that is to say if the open circuit voltage is determined during the charging from the flat battery to the fully charged battery. However, it is also possible to determine the open circuit voltage only when a partial cycle of the charging process is evaluated. The OCV characteristic curve is then adapted using suitable filters.

A further aspect of the invention relates to a battery having a module for determining the open circuit voltage of a battery, wherein the module is configured in such a way that a method for ascertaining the open circuit voltage of a battery can be carried out, wherein the open circuit voltage is determined during the charging process of the battery. The battery is preferably a lithium-ion battery or the battery comprises electrochemical cells which are embodied as lithium-ion battery cells.

Another aspect of the invention relates to a motor vehicle having an electric drive motor for driving the motor vehicle and having a battery according to the inventive aspect described in the preceding paragraph which is connected or can be connected to the electric drive motor.

However, the battery is not restricted to such a purpose of use but rather can also be used in other electrical systems.

The invention makes available a method for ascertaining the open circuit voltage during the charging of the battery pack for an electric or hybrid vehicle. By means of the method according to the invention, an ageing battery can advantageously also be observed precisely in terms of its power parameters and behavior parameters.

By means of the method according to the invention it is advantageously possible for the OCV in the vehicle to be determined reliably, which results in increased precision during the determination of the ageing-dependent power data.

Further advantages are an improved service life prediction, a more precise determination of the state of charge, precise determination of the aged capacity which is really available, a low degree of computing complexity and requirement for resources, as well as outstanding economic viability since there is no additional expenditure on hardware.

Advantageous developments of the invention are specified in the dependent claims and described in the description.

### DRAWINGS

Exemplary embodiments of the invention are explained in more detail with reference to the drawings and the following description, in which:

FIG. 1 shows a schematic illustration of a control-technology observer structure for estimating the state of a battery according to the prior art,

FIG. 2 shows a schematic illustration of a cell module according to the prior art, and

FIG. 3 shows a charge curve recorded according to the invention an an OCV characteristic curve.

### EMBODIMENTS OF THE INVENTION

In order to moniter the battery, a battery management system is provided which, using a control-technology observer structure 100, observes the battery 110 by means of a cell model 120 and ascertains the state of the real system by adaptation of the model parameters.

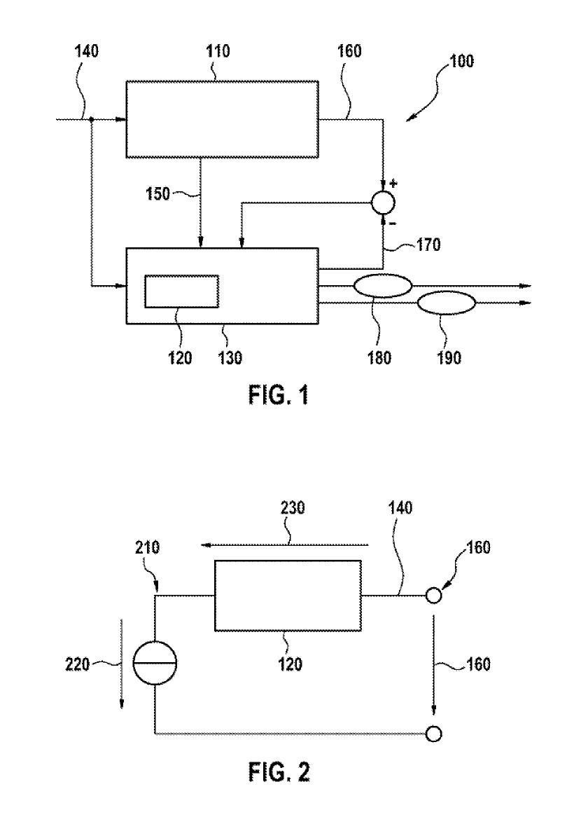

FIG. 1 illustrates such an observer structure 100. By means of the observer structure 100, the real system battery 110 is observed by means of cell model 120 and the state of the real system is adjusted by adapting the model parameters. The core of the observer 130 used in the observer structure 100 is a cell model 120 which basically has the structure illustrated in FIG. 2.

In an exemplary embodiment of such an observer 130, in order to estimate the state of charge 180 and to monitor the state of health 190, the real system battery 110 is observed by means of a cell model 120, wherein the battery current I_{batt} 140, the battery temperature T_{batt} 150, the battery voltage U_{batt} 160 and a model voltage U_{mod} 170, which is ascertained by the cell model 120, are evaluated. The state of the real system is adjusted by adapting the model parameters. The core of the observer 130 used in the observer structure 100 is a cell model 120 which basically has the structure illustrated in FIG. 2. The cell model 120 estimates the quiescent voltage U_{ocv} 220 under load. For this purpose, the battery current I_{batt} 140 is evaluated and in addition the voltage drop Uᵢₘₚ 230 at the battery impedance is subtracted from the measured cell voltage U_{batt} 160 in order to arrive at the internal voltage Uᵢ which corresponds to quiescent voltage U_{ocv} 220 in an ideal cell model 120. From the quiescent voltage U_{ocv} 220 which is ascertained in this way, the current state of charge SOC_{ocv} 180 is estimated using an OCV table.

Electric vehicles and so-called plug-in hybrids are charged by external or internal charging devices at a socket in order to be able to make available the necessary electrical energy in the next driving cycle.

For this purpose, continuous charging is generally performed with a constant charging power or constant charging current. This is utilized by the invention. In an exemplary embodiment of the invention, the voltage drop Uᵢₘₚ 230 across the cell impedance is ascertained using the cell model 120 illustrated in FIG. 2, which is already available in a battery management system according to the prior art.

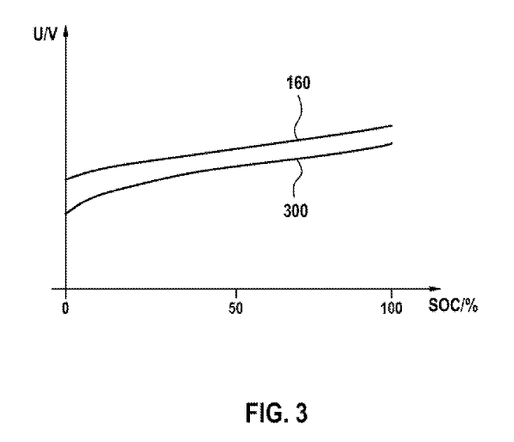

Since the temperature T_{batt} 150, the cell current I_{batt} 140 and the state of charge SOC_{ocv} 180 of the cell are already detected or ascertained by the battery management system, the voltage drop Uᵢₘₚ 230 at the cell impedance can be calculated by means of the cell model 120 and subtracted from the measured cell voltage U_{batt} 160. As a result, the OCV characteristic curve 300 can be recorded directly during the charging (cf. FIG. 3). The OCV characteristic curve 300 which is acquired during the charging is used to adapt the OCV characteristic curve which is stored and used in the battery management system. Furthermore, the OCV table of the battery management system can also be newly calculated using the OCV characteristic curve 300 which is acquired during the charging. Therefore, in this exemplary embodiment, the OCV table is measured during operation in the vehicle. In the method according to the invention, the OCV table is therefore newly ascertained taking into account possible errors in the cell model 120.

In the case of a continuous, slowly changing charging current, the determination of the impedance is advantageous and possible with high precision. Low charging currents, and therefore long charging times, are also advantageous here since the voltage drop Uᵢₘₚ 230 across the impedance is low in this case. Long charging times will be the usual case owing to the low power output of domestic sockets, with the result that, when the invention is used, these advantages are brought to bear in a large number of applications.

However, in addition, it is equally possible for the OCV characteristic curve 300 to be adapted during non-continuous charging.

In a further exemplary embodiment of the invention there is provision to apply an algorithm for filtering the change of the OCV characteristic curve 300. For example, brief faults in the measurement of the voltage are eliminated by using this algorithm, with the result that these faults do not have an adverse effect on the determination of the OCV characteristic curve 300.

It proves particularly advantageous if the entire range of the state of charge is run through, starting from a flat battery. However, by suitable filtering it is also readily possible to use only partial cycles of the charging process to adapt the respective range of the OCV characteristic curve 300.

The invention is not restricted in its embodiment to the preferred exemplary embodiments specified above. Instead, a number of variants are conceivable which make use of the method according to the invention, the battery according to the invention and the motor vehicle according to the invention, even in the case of configurations which are basically of a different type.

1. A method for ascertaining the open circuit voltage of a battery, comprising:
determining the open circuit voltage during a charging process of the battery.

2. The method as claimed in claim 1, wherein the battery includes at least one electrochemical cell defining a cell voltage, and the method further comprises:
ascertaining a voltage drop at an impedance of the at least one electromechanical cell, and
subtracting the voltage drop from the cell voltage in order to ascertain the open circuit voltage.

3. The method as claimed in claim 2, further comprising:
using a cell model of a battery management system to ascertain the voltage drop.

4. The method as claimed in claim 3, wherein at least one of (i) a characteristic curve of the open circuit voltage used in the battery management system, and (ii) an OCV table is adapted as a function of the determined open circuit voltage.

5. The method as claimed in claim 1, further comprising:
keeping the charging current constant during the charging process.

6. The method as claimed in claim 1, further comprising:
changing the charging current during the charging process.

7. The method as claimed in claim 2, further comprising:
ascertaining the cell voltage; and
filtering out faults in at least one of the ascertainment of the voltage drop, and the ascertainment of the cell voltage.

8. The method as claimed in claim 1, further comprising:
determining the open circuit voltage over an entire range of a state of charge of the battery.

9. A battery comprising:
a module configured to carry out a method for ascertaining an open circuit voltage of the battery,
wherein the method includes determining the open circuit voltage during a charging process of the battery.

10. A motor vehicle comprising:
an electric drive motor configured to drive the motor vehicle, and
a battery configured to be connected to the electric drive motor, the battery including a module configured to carry out a method for ascertaining an open circuit voltage of the battery,
wherein the method includes determining the open circuit voltage during a charging process of the battery.
